(19) United States
(12) Patent Application Publication
(10) Pub. No.: US 2010/0281909 A1
(43) Pub. Date: Nov. 11, 2010

(54) REUSABLE FLOW-DOWN BEVERAGE DISPENSER

(76) Inventor: Michael Carpanzano, New Milford, CT (US)

Correspondence Address: Gregory Stauf, 17 Dorset Drive, New Milford, CT, 06776, US

(21) Appl. No.: 12/776,555

(22) Filed: May 10, 2010

Related U.S. Application Data
(60) Provisional application No. 61/176,771, filed on May 8, 2009.

(51) Int. Cl. F25D 3/00; B67D 7/80

(52) U.S. Cl. 62/386; 222/146.6; 62/396; 62/389

(57) ABSTRACT

A reusable apparatus and process for dispensing, cooling and collecting a beverage are disclosed. In particular it relates to a beverage dispensers which may be used in a drinking establishment or party environment, which combines elements of decor or aesthetics with those of beverage cooling in a visible way. The dispensing part of the invention is via gravity induced flow, as the beverage is poured in to the top, flows along a channel on the surface of or through a tube within a container which holds chilled or frozen material but keeps it out of contact with the beverage, and releases the beverage to a receptacle, thus cooling the beverage flowing over or through the container. Methods and apparatus for using and enhancing the decorative nature of the container and cooling process are also disclosed.

### CROSS REFERENCE TO RELATED APPLICATIONS

This application is a U.S. Utility application taking priority from U.S. Provisional application No. 61/176,771 filed May 8, 2009 and herein incorporated by reference.

### BACKGROUND OF THE INVENTION

### References

U.S. Pat. No. 6,763,675, John H. Fleeman, Apparatus and Method for Preparing, Chilling and Dispensing a Beverage

The invention described herein relates generally to beverage dispensing devices and, more particularly, to reusable chilled beverage dispensers. In particular it relates to beverage dispensers which may be used in a drinking establishment or party environment, which combine elements of decor or aesthetics with those of beverage cooling in a visible way. The dispensing part of the invention is via gravity induced flow, as opposed to pumps or pressurization. Beverages as used herein refers to a liquid suitable for human consumption and also refers to any components or mixtures of such liquid, while liquid refers to any mixtures of liquids, colloids and solids, including but not limited to slushy drinks composed of ice/liquid mixtures or milkshakes, capable of flowing via gravity. Said liquids may contain dissolved gasses or solids, as well as decorative components harmless to humans including but not limited to glitter or coloring agents.

Ice sculptures are popular at drinking establishments or in party environments for the reasons discussed above. One popular way to perform the function of cooling while displaying a beverage at a party is an ice luge. An ice luge is typically a block of solid ice with one or more troughs carved or molded into a surface of the block of ice. The block of ice is then tilted on an angle and set on a slope so that a beverage can be poured into the one or more troughs. As the beverage flows down the one or more troughs, the ice block cools the beverage flowing down the one or more troughs. A person or people may position their mouths or a glass at the end of a respective trough to catch the beverage at is leaves the end of the respective trough. In other examples, blocks of ice may be formed with tubes or tunnel running through the interior portion of the ice block. Beverages are poured into the tube and are chilled as the beverage passes through the tube or tunnel within the ice block.

Generally, these ice blocks are formed in molds or carved by hand. As the ice melts the melt water runs along the table on which the ice block is placed. As such provisions must be made to contain the melt water so as to avoid damage to floors, tables, rugs, etc. In addition, the ice blocks generally can be used only once due the perishable nature of the ice block, requiring availability of a mold and storage for same, or a skilled ice carver for each event. Other disadvantages of the traditional system of using solidified blocks of frozen material include those discussed in U.S. Pat. No. 6,763,675, John H. Fleeman, Apparatus and Method for Preparing, Chilling and Dispensing a Beverage, which refer to risks of either diluting the beverage being poured down the block due to melting of the frozen material or freezing out certain components if the frozen material is extremely cold, for example, dry ice. Meanwhile, although a sculpture of ordinary material such as Lucite can be used, again as referenced in U.S. Pat. No. 6,763,675, this does not perform the function of cooling a beverage, which is important for the chilled beverage dispenser which is the subject of this invention.

It would be advantageous to have a reusable beverage chilling device into or into which a beverage can be poured and chilled as the beverage is flowing through the device.

### SUMMARY DISCLOSURE OF INVENTION

The present invention solves these and other problems as described below. One embodiment of this invention uses one or more containers shaped in the form of a slab of an ice luge. This container would have some premade combination of channels on one or more surfaces and tubes through which a beverage could flow. Such a container is filled with a fluid, including, but not limited to, water, and chilled or frozen in a suitable location such, but not limited to, a refrigerator or freezer. This container is then placed on a stand which tilts it such that beverages can be poured onto or into the passageway, flowing to the bottom where said beverages are drunk or decanted into a container, while keeping said beverages out of contact with said fluid providing a chilling effect. Different types of ends can be placed on the outlet of the channels or tubes, including ones shaped for pouring into a glass or ones shaped for drinking directly from the outlet of the channel or tube, said ends shaped for drinking directly from said outlet potentially being used by each individual for sanitary reasons.

### BRIEF DESCRIPTION OF DRAWINGS

FIG. 1 shows the container with channels on the front surface mounted on a stand which tilts it to allow beverage dispensing.

FIG. 2 shows a dismountable dispensing attachment for the container, designed to dispense into a glass or other secondary container.

FIG. 2a is a side view of the dismountable dispensing attachment of FIG. 2, showing where magnets or other fasteners can be used to fasten the attachment to the bottom of the channels.

FIG. 3 shows a dismountable dispensing attachment for the container, designed to allow for an individual to mount it onto the dispensing end of the container and drink the beverage directly from the bottom of the channel or tube.

FIG. 4 is a view of a possible system for putting a beverage into the top end of a channel or tube on the container, a “shot rotisserie”.

FIG. 5 shows the container with a secondary coil for active cooling of the container contents.

FIG. 6 shows a side view of the container with an active cooling system in the stand beneath and an evaporator for the cooling system in the container for direct cooling of the fluid in the container.

### MODE(S) FOR CARRYING OUT THE INVENTION

### Detailed Description

The present invention and its various embodiments are described below, with reference to figures as necessary. Reference numbers are used to match particular elements described in the text with those shown in figures. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

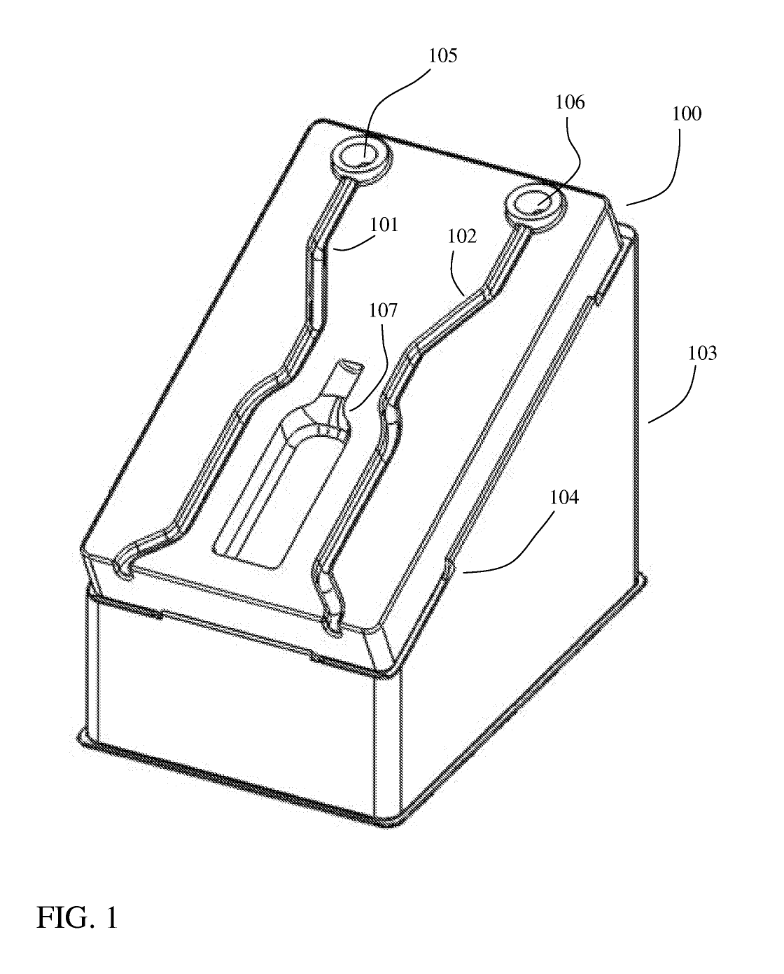

Generally speaking, the present invention describes an apparatus and associated methods of construction and operation for dispensing a chilled beverage. More particularly, this invention applies to a beverage chilling system intended partially for decorative and display use and making use of gravity to dispense the beverage, rather than a conventional industrial refrigerated system for pressurized or pumped beverage dispensing. The beverage so dispensed may arrive in one or more receptacles such as glasses, or be drunk directly from the outlet(s) of the apparatus. FIG. 1 illustrates a beverage dispenser having a housing or container 100 which is configured to chill any suitable beverage that is poured into one or more troughs or passages 101, 102 of the beverage dispenser as that beverage passes through the trough or passage. It should be realized that while the exemplary embodiments will be described herein with respect to the cooling of a beverage, in other examples any suitable fluid may be cooled as the fluid passes over a surface of or through an internal portion of the container 100. It should also be realized that container 100 can be made in multiple parts which can be fitted together in order to make a larger beverage dispensing surface. This can be for reasons including but not limited to more convenient storage when not in use, fitting into a restricted space for display and fitting into a refrigerator or freezer shelf of limited size. It can also allow more complex displays to be built up in a modular fashion, by assembling smaller units of the dispensing system, perhaps even becoming the focus of a puzzle type party game.

In this example, the beverage dispenser includes a stand 103 for supporting the container 100 thereon. It is noted that while the container 100 is shown as being separate and distinct from the stand, in alternate embodiments the one or more containers may be formed integrally with the stand in a unitary construction so that the container 100 has a substantially flat base and an angled top surface. It is also noted that while stand 103 is shown as a single piece, it can be rigid or collapsible, can be built to fold for storage, and can also be built as part of the container 100, i.e. the container can have panels which fold downwards in a variety of configurations known to those skilled in the art in order to support itself. The visible surfaces of the stand may be textured in such a way as to match or complement the container. The frame may have any suitable shape and size and be constructed of any suitable material including, but not limited to, metals, plastics, wood and composites. The surface supporting the container may take several forms including, but not limited to, a solid surface, a frame with solid side panels, a frame with legs, or individual legs attached to the container. The stand 103 is shown to have flanges or brackets 104 in order to hold the container 100 in place when the container is tilted. These flanges can take many forms known to those skilled in the art, including being hidden under the container on the stand surface where they could take forms including, but not limited to, one or more wires such as are used in hanging a picture, interlocking grooves, or magnets. It is also possible to make the stand such that the tilt angle of the container on top is adjustable, or to interchange stands to change the tilt angle of the container. This would allow the container 100, for example, to have a steeper slope if used for a relatively viscous beverage such as a frozen Daiquiri or a milkshake, and a shallower one for a pure liquid such as lemonade. It would also allow for adjustment of tilt angle if necessary for particular configurations of troughs or tubing on or in the container which may have shallower or steeper angles in them, such that they can empty fully. As with the container itself the stand can be made in such a way that it disassembles into pieces for display, storage or transport. Finally, it is possible to mount the container on a pivot or axel such that its tilt could be adjusted while in use or on display, perhaps revealing a particular picture or pattern only when desired as part of the exhibition, or even reversing the inlet and outlet of the dispensing system.

The container 100 may be a hollow container having any suitable size and shape and be configured to contain or house a cooling fluid or gel. This fluid or gell should have high heat capacity, ideally undergoing a phase change which stores large amounts of energy, such as but not limited to water, which freezes into ice. The container may also be refillable and thus equipped with fill and/or drain plugs to facilitate addition and removal of a particular cooling fluid. It may also be desirable to use solid materials such as dry ice inside the container to chill it, and a completely solid object can be used for this dispenser for reasons of convenience but is likely to be less advantageous for reasons of lower total heat capacity then a material capable of undergoing a phase change. The container 100 may be formed in any suitable manner including, but not limited to, blow molding, bending, stamping, welding, extruding, etc. The container 100 may have funnels or other larger openings 105 and 106 to facilitate pouring a beverage into the upper end of the channels 101 and 102 The container 100 may also be constructed of any suitable material including, but not limited to, plastics, composites, metals, vinyls, acrylics, or any other suitable material. It is desirable to make the container 100 out of a material with good heat transfer, such as metal, but metals may transfer an unpleasant taste to the beverage, so it may be desirable to use a non flavor inducing coating on the container. This coating may be applied to the entire container 100, or just to the side with troughs, or just to the troughs 101 and 102. It may be important to use a “food grade” coating for this coating or the entire material of the container, as it will be in contact with beverages intended to be drunk by humans. It may also be important to use a material which can be cleaned and sterilized, since a primary purpose of the invention is to provide a reusable beverage chilling and dispensing system. The container may have insulation on one or more sides to prevent heat loss and condensation. In particular it may have insulation between it and the stand, on the sides, and on the front or top surface, with the exception of on the passage surfaces where heat transfer from the beverage through the container wall to the fluid or solid inside may take place. In particular this insulation could be designed to enhance the theme of the dispenser, for example foamy material if it is to be used as a display for a bubble bath product or a beer. In one example, the walls of the container 100 may be transparent, translucent, opaque or otherwise configured so the walls are substantially solid in color. The walls of the container 100 may be configured with any suitable textures, patterns or other visual features. For example, the container 100 may be textured such that the containers mimic a block of ice or any other suitable item. The texture may include graphics, text or other indicia. In another example, the container 100 may include a colored cooling fluid or a cooling fluid having glitter or other visual effect such as UV active fluorescent dyes as is known in the display arts. Thus, although it is likely that due to wide availability, low cost and a freezing point which is accessible in a wide variety of commercial refrigeration apparatus, water will be a major component of the fluid used in the container, other materials may be added to it for reasons including, but not limited to, stability (e.g. a biocide), visual decoration, or viscosity changes. The amount of said additives may vary depending on the effects which are desired. In still other examples, lighting may be placed within or behind the container 100 or under, behind or inside stand 103 for ambience lighting or otherwise visually stimulating users of the beverage dispenser 100.

While troughs 101 and 102 are shown in this example, it is possible to use channels of a variety of cross sections including, but not limited to, U shaped and V shaped. It is also possible to use enclosed tubes for part or all of the passage of the liquid. If tubes are used, this also allows for the possibility of more complex 3-dimensional patterns in the container 100, as they can cross each other. It also allows for the outside surface of the container to remain flat, which may permit some decorative designs or effects which would otherwise be difficult. Said 3-dimensional patterns could include, but are not limited to, spirals, zigzags, and shapes matching pictures or figures on surfaces of the container 100. More complex, lengthy passages allow both for more elaborate displays and more effective cooling of the beverage due to longer times in contact with the cooling surface. The term passages will be used in this patent to refer to any shaped surface including, but not limited to, channels, troughs, passages and tubes along which or through which beverages can pass by gravity. The container can also be made with channels on its back surface, facing the stand. This allows both for more than one pattern to be made on a container, increasing its flexibility of usage, and if the seal between the container 100 and the stand 103 is liquid tight, usage of the channels on the rear of the container 100 to chill beverages as well as the channels 101 and 102 depicted on the front.

It is also possible to produce textures in or on the surfaces of the passages, such as but not limited to, ridges, stair steps, and cooling fins. These textures can have purposes such as, but not limited to, enhancing the decorative nature of the invention, causing turbulence to aerate the beverage flowing over them or improve heat transfer, and increasing surface area of the container in order to increase heat transfer. Passages may undulate back and forth parallel to the face of the container, as shown in FIG. 1, or in a direction perpendicular to the face of the container, if it is produced with a more wavelike surface. Finally, any number of passages may be used from one to many dozens, for purposes including but not limited to decorative effect, mixing multiple components of a beverage from multiple source containers and sending them to one or more receptacles at the lower end of the apparatus, and splitting one or more components of a beverage to multiple outlets and thus to multiple receptacles at the lower end of the apparatus.

The outside surface of the containers may be configured with any suitable texture and have any suitable indicia, such as for advertising or any other suitable purpose. The indicia may be formed onto the surface of the container, may be applied to the surface of the container (such as with adhesive or painted) or the indicia may be removably applied to the surface so that the indicia may be changed depending on, for example, an event as which the beverage dispenser 100 is used. The container 100 can be translucent or transparent, allowing lights to be shined into or through it, such as, but not limited to, lights from the back or stand side of the container. In one example, the one or more troughs 101, 102 may form the indicia. For example, as can be seen in FIG. 1 the troughs 101 and 102 substantially form a stylized outline of a human form with arms raised. The shape of the indicia formed by the troughs may be conducive or complimentary to the application of designs to the containers. In other examples, the troughs may form words, pictures or any other suitable shapes, including, but not limited to, distinctive outlines of particular bottles of beverage, names of people being celebrated at a party or corporate logos. In one exemplary embodiment, in addition to the troughs or internal passages, the containers may have formed therein, such as on a heat exchange surface of the container, one or more cavities 107 having any suitable shape for holding or cooling separate beverage containers, such as for example, bottles or cans. The cavity 107 may be formed in substantially the shape of at least a portion of the separate beverage container so that the separate beverage container may be stably placed on the beverage dispenser for cooling. The modular nature of the container 100 and stand 103 allow the subject beverage dispenser apparatus to be packaged as a kit and be bundled for sale with other products. A cover can also be designed for said container such that it has openings, also possibly forming patterns or indicia. This cover can also expose some portions of said troughs or passages while concealing others, allowing for a party type game or puzzle to work out where said troughs or passages are or what they do.

Beverage passages/internal heat exchange surfaces formed within the containers may also be configured with different shapes in a manner substantially similar to that described herein with respect to the troughs. In one exemplary embodiment, where the container 100 includes internal heat exchange surfaces, the container may include removable inserts where the inserts include the beverage passages. Each removable insert may have a different configuration of passages so that a design or indicia formed by the passages may be changed by swapping out the removable inserts. Tubes or hoses may be inserted into the container 100, passing through the walls, such that they extend out of the container 100 at one or both ends, allowing beverage to be conducted through the container 100 and being chilled through heat transfer through the walls of said tubes or hoses.

The space under the stand 103 may have a drip tray, to catch any condensation on the beverage dispensing system or dripping/overflow from the troughs or container. The space under the stand may also have additional decorative features intended to produce special effects, including, but not limited to, a fog or mist machine and its water supply, lights, which may be static, multicolored, moving and/or flickering, sound systems, laser light show system, or slide or video projectors, in order to enhance the ambience of the gathering and potentially reinforce any commercial messages associated with the system.

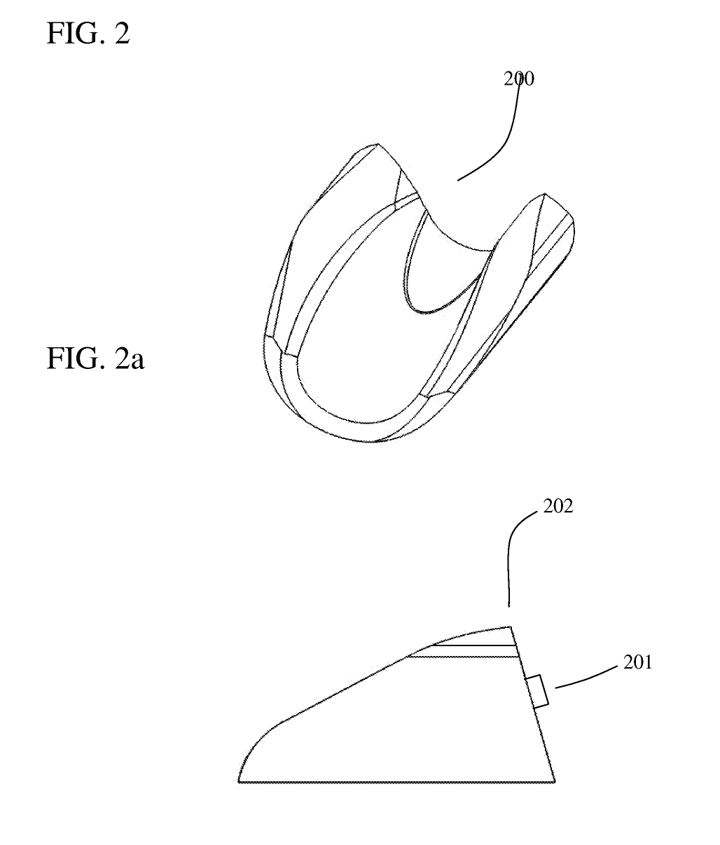

As seen in FIG. 2, a detachable outlet 200 can be attached to the lower, or dispensing end of the passages in the container. The outlet 200 is intended for dispensing the beverage into a receptacle such as a secondary vessel or glass. The dispensing ends of the troughs 101 and 102 are equipped with some fastening device 201, such as but not limited to magnets, hooks and loops, snaps, clips, mating grooves, holes or plugs. It would be possible by using an electrically active connection to have devices such as, but not limited to, lights or a moving object built into or forming the outlet 200 for aesthetic effect. In FIG. 2a a side view of the detachable outlet is shown, with possible locations for the fastening device 201. It can also be seen that the side of the outlet 200 which would mate to the lower end of the container 100 at a trough 101 or 102 is angled. As discussed previously, different angles of the container 100 may be needed for different viscosities of beverages, layouts of passages or decorative effects. It is thus advantageous to have an easily removable and replaceable outlet so that a variety of them can be used with any one container/stand combination.

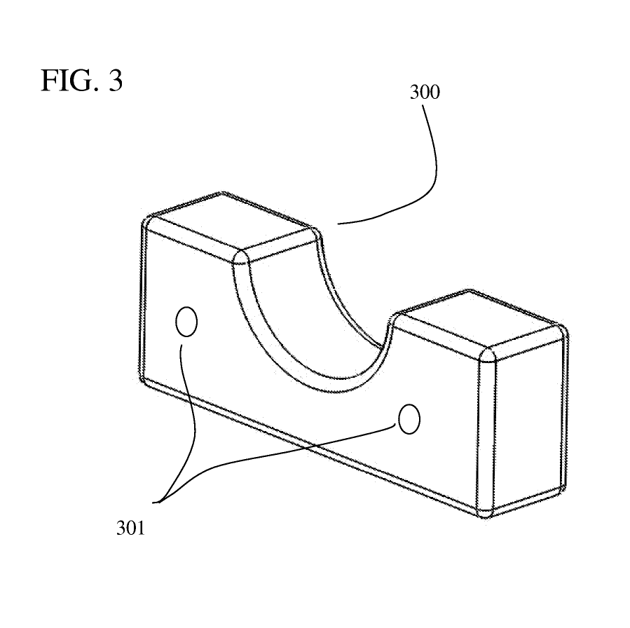

FIG. 3 shows another type of dispensing outlet 300 intended to let a partygoer drink directly from the lower end of a passage 101 or 102, without dispensing into a secondary vessel such as a glass. In this case, the easily removable and replaceable dispensing outlet allows multiple, inexpensive outlets to be used for sanitary purposes. This implementation permits giving one to each partygoer or having a basket next to the beverage dispensing apparatus. This exemplary outlet in particular encourages an easy mechanism for attaching the outlet such as magnets 201 or 301, as it will be done by untrained partygoers. In this example the human mouth acts as the receptacle into which the beverage is directed at the outlet of the passage.

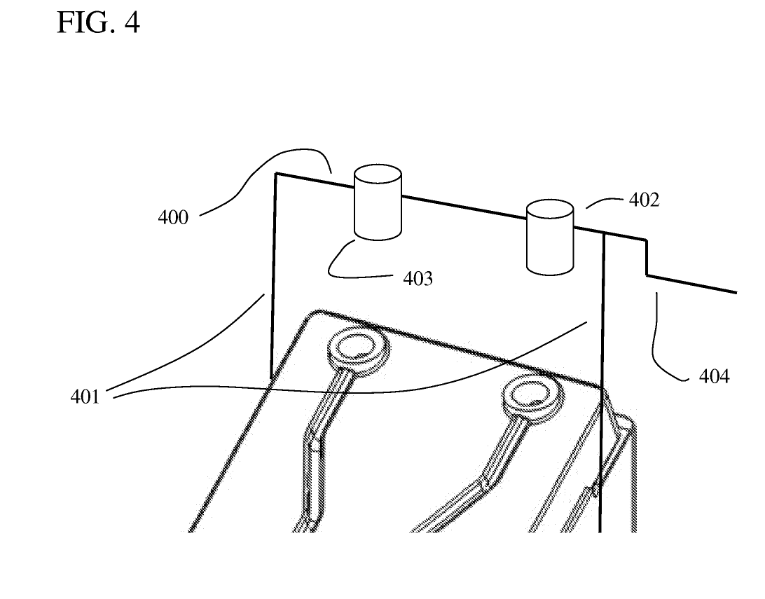

For the inlet of the beverage dispensing apparatus, several different systems can be used. The simplest was shown in FIG. 1, merely a location to pour a beverage into by hand. In another example an inlet of the trough may be shaped to accept a bottle or other separate beverage container so that the beverage flows directly from the bottle resting within the trough. As may be realized the beverage dispenser may be configured with a beverage metering device of a type known in the art so that a predetermined amount of fluid exits the separate beverage container and passes through the trough. FIG. 4 shows another alternate embodiment, a rotisserie device 400 that is configured to pour predetermined amounts of a beverage into the trough. In one example the rotisserie device consists of a rod 400 which is substantially horizontal and supported by at least two legs 401 in such a way that the rod 400 can rotate around a longitudinal axis. Two shot glasses 402 and 403 (or any other suitable beverage container) such that the predetermined amount of beverage may be, in one example, substantially equal to a shot (e.g. about one to about one-and-one-half an ounce) of the beverage are attached to said rod 400 in a way such that in at least one rotational orientation they can contain a beverage. One or more beverages are placed into at least one glass 402 or 403, then a device including, but not limited to, a manual crank 404 is used to rotate the rod By using differently sized containers in the rotisserie, mixed drinks of predetermined ratios at the outlet(s) of the passages could be achieved, with different drinks being mixed based on which shot glasses in the rotisserie were filled or which passages were used. In alternate embodiments the predetermined amount of beverage may be any suitable amount that may depend on a capacity of the beverage container held by the rotisserie device. In still other examples, there may be beverage container holders or shelves located, for example, above the troughs and configured so that a metered amount of beverage is released from the beverage container into a respective trough.

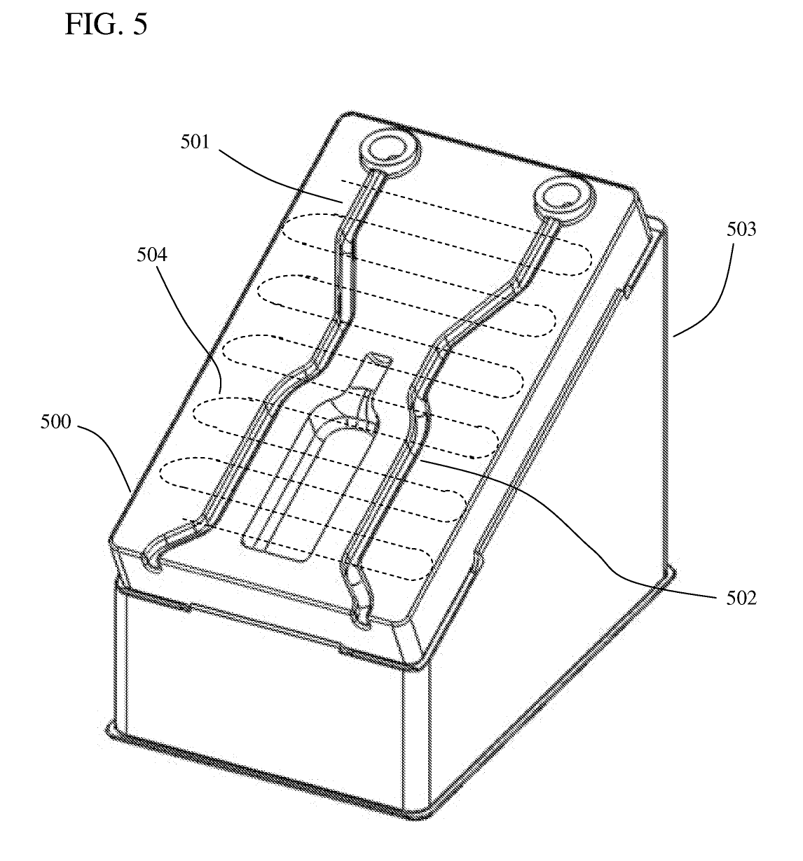

FIG. 5 shows another exemplary embodiment of the subject beverage dispenser. The container 500, troughs or passages 501 and 502 and stand 503 may be very similar to corresponding items 100, 101, 102 and 103 from FIG. 1 and share common features with them. The difference is that rather than the container 500 being cooled in a refrigerator or freezer then removed for use or display, a cooling coil 504 is used to actively cool the container 500.

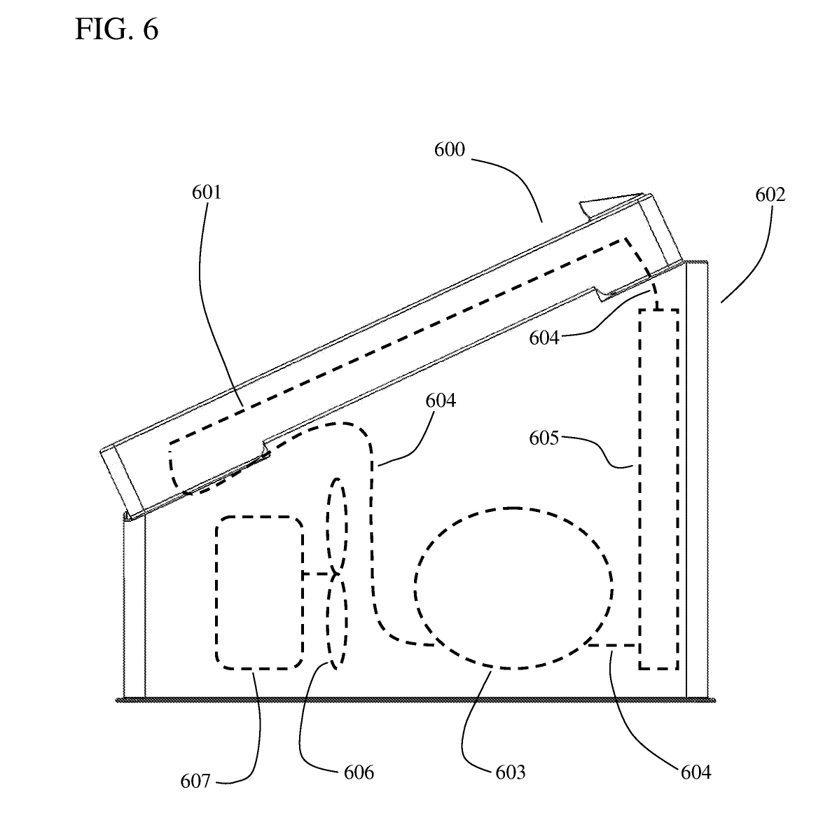

FIG. 6 shows this exemplary embodiment in cross section. In it, container 600, which corresponds to container 500 shown in perspective view, is chilled via cooling coil 601, which corresponds to the coil shown in 504 in perspective view. In this embodiment, the cooling unit is placed under stand 602, which corresponds to item 103 from FIG. 1, though it is to be understood that other placements near the container 600 are possible. This embodiment shows a standard vapor compression or Carnot cycle refrigeration system, wherein the evaporator coil 601 has been placed directly in the container 600 in order to keep it in intimate contact with the fluid in container 600. Compressor 603 drives refrigerant such as a Freon or Freon substitute through tubes 604 to the evaporator 601 and to a condenser coil 605, with heat being removed from the entire system by means of the cooling fan 606 driven by motor 607.

In a more decorative example, a cooling fluid, possibly containing decorative elements including, but not limited to, glitter, coloring agents, or UV active fluorescent dyes can reside in a reservoir in the chilling unit or mounted near the container 500, with this cooling fluid being cooled in the chilling unit and recirculated through the container 500. This reservoir can be hidden or exposed depending on the effect desired. In such an embodiment tubes or hoses can be used to circulate a cooled fluid generated by the refrigeration system to a coil 501 or other closed circuit heat transfer system attached to or within the container 500, or surrounding passages within the container for chilling of beverages passing through said passages, or can by means of inlets and outlets in container 500 directly recirculate the fluid in container 500 through the heat exchanger in the refrigeration system keeping said fluid in container 500 cold. As is apparent to one skilled in the art, many variants of cooling system could be used to actively chill the container 500, including, but not limited to, thermoelectric or Peltier effect coolers if silent or ruggedized operation is desirable at some cost in efficiency.

The exemplary embodiments described herein may be provided as beverage dispenser kits. The kits may be provided with multiple containers 100 or 500 each having the same or different configurations (e.g. surface texture, opacity, translucency, transparency, colors, fluid flow passages/troughs, cooling fluids, etc.) such as those described herein. The kits may also be provided with multiple beverage dispensing attachments 200 and/or mouth pieces 300 and other accessories including, but not limited to, the rotisserie device. In alternate embodiments the beverage dispenser kits may include any suitable components. It would also be possible to use any of these embodiments to heat a beverage, by placing container 100 into an oven which heats it to some temperature suitable for the container material, placing them out on display and pouring beverages through them, or by connecting container 500 to a recirculating fluid system which heats fluid instead of cooling it. Parties are more frequently held in “room temperature” environments wherein temperatures are generally in the 62 to 80 F (17 to 27 Celsius) range or, in the case of outdoor parties, in temperatures as high as around 120 F (49 Celsius). In warmer times of year and warmer climates parties tend to both be more frequent and to be more likely to feature “ice cold” beverages wherein the subject invention may be employed.

It should be understood that the foregoing description is only illustrative of the embodiments. It should also be understood that the embodiments disclosed herein may be used individually or in any suitable combination thereof. Various alternatives and modifications can be devised by those skilled in the art without departing from the embodiments. For example the actively cooled version of this invention could embody a largely solid dispensing device with channels through which cooling fluid flows, rather than a largely liquid filled container as described in the detailed embodiments herein. Accordingly, the present embodiments are intended to embrace all such alternatives, modifications and variances.

In one exemplary embodiment, a beverage dispenser is provided. The beverage dispenser includes: at least one hollow container configured to hold a cooling fluid, the container having at least one heat transfer surface, a first end and a second end; at least one fluid passage in communication with the at least one heat transfer surface, the fluid passage being configured to carry fluid from the first end of the container to the second end of the container, wherein the fluid carried by the at least one fluid passage is cooled as it is carried by the fluid passage; and a stand configured to support the heat transfer surface at an angle for effecting fluid flow as the fluid is carried by the at least one fluid passage.

What is claimed is:

1. A reusable apparatus for cooling and dispensing a beverage, the apparatus comprising:
a container, capable of containing a fluid or solid or mixture thereof and being cooled together with its said contents below room temperature;
one or more passages in said container capable of directing the flow of said beverage, said passages being arranged so that when said container is oriented for use, said passages have a generally downwards slope; and
at least one inlet and one outlet for said passages such that when said container is oriented for use a beverage can be poured into the higher outlet of at least one of said passages and flow by means of gravity out of the lower outlet of at least one of said passages, wherein when said container and its said contents are colder then the ambient surroundings, they will cool said beverage as said beverage flows through said passages in said container.

2. An apparatus as defined in claim 1, wherein said fluid in said container can undergo a phase change to provide a large thermal mass for cooling said beverage.

3. An apparatus as defined in claim 1, wherein said fluid in said container is more than 40% water.

4. An apparatus as defined in claim 1, wherein said fluid in said container contains decorative elements in said fluid.

5. An apparatus as defined in claim 1, wherein said passages are arranged in a specific decorative pattern.

6. An apparatus as defined in claim 1, wherein said passages consist of one or more troughs on a substantially flat surface of said container.

8. An apparatus as defined in claim 1, wherein said passages consist of one or more tubes inside the body of said container.

9. An apparatus as defined in claim 1, wherein at least one of said passages consists of one or more combinations of troughs on a substantially flat surface of said container and one or more tubes inside the body of said container.

10. An apparatus as defined in claim 1, wherein said passages intersect in the down slope direction, allowing for mixing of one or more beverages from components added at the top of said apparatus.

11. An apparatus as defined in claim 1, wherein said passages divide in the down slope direction, allowing for dividing a stream from one or more beverages added at said higher inlet of at least one of said passages into multiple streams to go to multiple receptacles at said lower outlets of said passages.

12. An apparatus as defined in claim 1, wherein arrangements are made for attachment of a device at the outlet end of at least one of said passages wherein said device is easily interchangable and serves to direct the beverage to a receptacle.

13. An apparatus as defined in claim 1, wherein arrangements are made for attachment of a rotisserie device at the inlet end of at least one of said passages wherein said device has at least one cup attached to a rod in such a way that in at least one rotational orientation of the rod along said rod's long axis said cup can contain a beverage while in another rotational orientation of said rod said cup empties itself and which after putting a beverage into said cup can cause by means of rotation of said rod around said axis said cup to empty its contents into the inlet end of one or more passages.

14. An apparatus as defined in claim 1, wherein an indentation of a particular shape matching that of a particular vessel with a beverage in it is made in at least one surface of said container in order to cool said vessel and beverage.

15. An apparatus as defined in claim 1, wherein a cooling system is used to chill the fluid in said container while said container is in use.

16. An apparatus as defined in claim 1, wherein a stand designed for use with said container is used to support said container.

17. An apparatus as defined in claim 16, wherein said stand has means to adjust the angle of said container and orient it for use such that said passages have a substantially downwards slope.

18. An apparatus as defined in claim 16, wherein said stand includes systems to generate special effects.

19. A method for cooling and dispensing a beverage, by using a container, capable of containing a fluid or solid or mixture thereof and being cooled together with its said contents below room temperature and having one or more passages in said container capable of directing the flow of said beverage, said passages being arranged so that when said container is oriented for use, said passages have a generally downwards slope and having at least one inlet and one outlet for said passages such that when said container is oriented for use a beverage can be poured into the higher outlet of at least one of said passages and flow by means of gravity out of the lower outlet of at least one of said passages, comprising:
cooling said container with its said contents;
orienting said container such that such that at least one of said passages has a substantially downwards slope;
putting at least one beverage into at least one upper inlet of at least one of said passages in said container;
flowing by means of gravity said beverage through at least one of said passages;
cooling said beverage by heat transfer from said beverage through a wall of at least one of said passages to the contents of said container; and
dispensing said beverage from a lower outlet of at least one of said passages to a receptacle.

20. A process as defined in claim 19, adjusting flow of said beverage by orienting said container using a stand such that said passages have various downwards slopes depending on properties of said beverage.
